(19) United States
(12) Patent Application Publication
(10) Pub. No.: US 2014/0101596 A1
(43) Pub. Date: Apr. 10, 2014

(54) LANGUAGE AND COMMUNICATION SYSTEM

(71) Applicant: Over The Sun, LLC, Loveland, CO (US)

(72) Inventors: Kai Staats, Loveland, CO (US); Bruce Geerdes, Broomfield, CO (US); Daniel Burcaw, Denver, CO (US); Lindsay Giachetti, Denver, CO (US); Ben Reubenstein, Denver, CO (US); Matthew Crest, Morrison, CO (US)

(73) Assignee: Over The Sun, LLC, Loveland, CO (US)

(21) Appl. No.: 14/109,128

(22) Filed: Dec. 17, 2013

Related U.S. Application Data
(62) Division of application No. 13/020,638, filed on Feb. 3, 2011.
(60) Provisional application No. 61/301,084, filed on Feb. 3, 2010.

(51) Int. Cl. G06F 3/0488

(52) U.S. Cl. CPC G06F 3/04886
USPC 715/773

(57) ABSTRACT

A device disclosed herein comprises a touch screen interface configured to display a plurality of different keyboard configurations, each of the keyboard configurations representing a plurality of keys, receive an input from a user to select one of a plurality of keyboard selection inputs, and in response to the selection of the one of a plurality of keyboard selection inputs, displaying a selected keyboard configuration from the plurality of different keyboard configurations, wherein each of the plurality of keys related to the selected keyboard configuration represents a word.

### CROSS REFERENCE TO RELATED APPLICATIONS

The present application is a divisional application under 35 U.S.C. §121 of U.S. patent application Ser. No. 13/020,638 filed Mar. 2, 2011 and titled “LANGUAGE AND COMMUNICATION SYSTEM” which claims benefit of priority to U.S. Provisional Patent Application No. 61/301,084, entitled “LANGUAGE AND COMMUNICATION SYSTEM” and filed on Feb. 3, 2010, both of which are specifically incorporated by reference herein for all that they disclose or teach.

### BACKGROUND

Human communication has evolved throughout prehistory and history. In many cases, technology changes have contributed to this evolution. For example, humans developing the capability of speech roughly 200,000 years ago represent an important step for human communication, followed by symbols some 30,000 years ago, and writing about 7,000 years ago. In comparison, it is only in the very recent few centuries that the printing press, telecommunications, computers, and digital communication technology have accelerated the rate of evolution in human communication.

Computer technology has certainly enhanced this evolution. Computer-connected networks have enabled worldwide communication of data and have developed into the World Wide Web and other communication networks. Terrestrial and extraterrestrial communication nodes support multiple global networks that connect computers and telecommunications devices of diverse populations, from individuals to international corporations and governments. Mobile telephones and computers can connect individuals over large geographic regions using voice, video, data, and text messaging content. In a word, digital communications among humans is becoming “ubiquitous” on a worldwide basis.

A more recent development involves a phenomenon called “social networking,” which focuses on building social relationships among populations of humans through the use of computer-assisted communications, whether that technology is mobile or not. Individuals may connect with other individuals on a small or large scale based over similar interests, shared contacts, etc. With the added parameter of mobility, the character of these digital communication channels suggests an almost real time quality.

[However, with more than 6000 spoken languages on the planet, less than 1% comprise the most commonly used written languages for daily digital communication, most of which are completely exclusive from the others when transmitted from one person to the next, requiring a human or computer based translator. Even the best automated translation introduces contextual errors that may result in misunderstanding or misinformation.

As such, even with the rapid growth and world-wide adoption of social networking software systems, human communications remain relatively associated with same-language peoples, a form of isolation that has not to date been surpassed.

### SUMMARY

Implementations described and claimed herein address the foregoing problems by providing an innovative language system and global/mobile network-based platform for social networking and messaging built on a vocabulary of symbols holding a universal meaning that transcends barriers of language and regional dialect through a complete system of cross-referencing and evolution. Individuals can contribute to the language and absorb new aspects of the language as it evolves globally. Furthermore, the symbol vocabulary is faster than some text-based communications as it is intended to communicate broader concepts with fewer keystrokes.

The new language and communication system also presents opportunities for commercial benefit. As system use proliferates, commercial entities can sponsor their own symbols, collect real time symbol use data (whether geographically-based or not), and provide promotional benefits to consumers based on the use data.

Other implementations are also described and recited herein.

### BRIEF DESCRIPTIONS OF THE DRAWINGS

FIG. 1 illustrates an example interface to a new language and communication system.

FIG. 2 illustrates an example network connecting various devices in a new language and communication system.

FIG. 3 illustrates an example computing system that may be useful in implementing the described technology.

FIG. 4 illustrates an example block diagram of server-side flow during message generation and response.

FIG. 5 illustrates an example graphical user interface that allows a user to modify an icon.

FIG. 6 illustrates an example keyboard layout used by the system disclosed herein.

FIG. 7 illustrates an example graphical user interface that allows a user to define a picture as a note.

FIG. 8 illustrates an example graphical user interface that allows a user to create a customized twitter message.

FIG. 9 illustrates an example of the screen that follows FIG. 11.

FIG. 10 illustrates an example of graphical user interface.

The graphical user interface of FIG. 10 allows a user to conduct a natural language key word search in real-time where all characters in the current vocabulary are presented as options for message composition.

FIG. 11 illustrates example diagrams and descriptions of modifiers.

### DETAILED DESCRIPTIONS

The system described herein improves upon traditional text messaging (“SMS”). With SMS, each letter is entered individually to form the word in the User's native language (for example, English), or a dictionary (for example, Nokia's “T9”) is used to assist the User in spelling the word, sometimes reducing the number of keystrokes required to complete the word. The dictionary ‘guesses’ at the intended word, reducing the number of possible words with each additional letter entered. Once the intended word is spelled fully by the User, or the User is able to select the intended word from the list given by the dictionary, the User then introduces a space and the next string of characters to construct the next word or completes the phrase to be sent to the intended recipient.

With SMS, the number of keystrokes required to construct a word is no less than the number of letters in the word or the number of keystrokes required to invoke the on-board dictionary to display the correct word plus the use of the arrow (up, down) keys to select the correct word followed by the “enter” key to make the selection. If the average text message is comprised of five words, each of which contains five letters, then the number of keystrokes is 5 multiplied by 5 plus the spaces between for a total of 29 keystrokes. The same message composed with a dictionary may be reduced, on average, to roughly ⅔ this or 20 keystrokes. But with the system described herein, the User is enabled to organize his or her Keyboard Category “Buckets” to maximize the efficiency of message creation by placing the most used system characters into the Buckets 1 through 5 whose content is limited to the number of characters contained by a grid of 9 columns wide by 6 rows tall for 54 characters total. Without left/right or top/bottom scrolling, each of these Buckets becomes its own, self-contained keyboard whereby a single contact from the finger or mouse button triggers an entire word to be placed into the message being composed. In this respect, the Keyboard described herein is reducing the complexity and time required to communicate to a bare minimum of 1 keystroke to switch Buckets plus one keystroke to select the character representing the desired word. If more than one desired character in a row is found in the same Bucket then the number of keystrokes for those sequential characters is one each.

Given the prior 5 word example, using the system described herein the User would require no more than 10 and as few as 5 to generate the same message, if it may be assumed the vocabulary used is immediately available within the 5 Keyboard Category “Buckets” where the User has placed his or her most used characters in the system described herein. This is a reduction at best of 29:5 and at worst 20:10 or a 50% reduction in keystrokes to generate a message. For example, a Phrases bucket provides a location for the User to store entire phrases for reuse as-is, or for reuse with minimal modification prior to delivery to the intended recipient (Friend).

An implementation of the system disclosed herein allows a user to send messages to users using language described herein. The client application enables this through the use of the keyboard, a unique on-screen keyboard designed to grant the User the fastest, most efficient means possible of accessing hundreds of characters. Given a User who has a message he or she desires to compose and send to a Friend:

1. Having engaged the keyboard screen, if the User does not immediately see the first word of his or her message presented by a character on the default Bucket keyboard, then the User selects the Bucket that contains the desired character.

2. This process of selecting and reviewing the Buckets is continued until the Bucket with the desired character is located or the User elects to conduct a native language word search using the Search function (see Native Language Character Search).

3. The User now selects the desired character, a copy of which is automatically placed into the left most position of the message composition window, a previously empty text entry field.

4. The User then continues to select additional characters, as many as are required to complete his or her intended message, each subsequent character automatically positioned to the right of the previous character in the message composition window.

The completed message may be sent to the intended, receiving Friend without further modification by selecting the control “Send”. Or, the user may further modify the characters to be given adjective, verb, adverb, possessive, and time indications of “past tense”, “present tense”, or “future tense”.

These modifications are conducted as follows:

1. User selects the one character from the message composition window to be modified.

2. A new window is invoked with the heading “Modify this icon”.

3. The options for Possessive, Past Tense, Future Tense, Adjective, and Adverb are presented, each with a checkbox to the left of their controls. The selection of one check box may remove the option of another. For example, a word cannot simultaneously be both Past and Future tenses, therefore when Past tense is selected, the control for the Future tense option is immediately disabled. The same is true for Adverb vs. Adjective where if the User selects Possessive, the Adjective option is auto-selected and the Adverb option is disabled.

4. The Notes input box is provided for the inclusion of User introduced notes, in the User's native language, such as a specific street address associated with the character for ‘restaurant’ or the time of day associated with the character for ‘clock’.

5. When finished with the modifications” the User selects the control labeled “Done” and the User is returned to the Keyboard and Composition screen.

6. The character that was modified by the provision of META data is now visibly modified with the addition of one or more symbols in the top-left, top-right, bottom-left, bottom-middle, or bottom-right of the character box, as follows:

Top-left—diamond: This modification denotes that this character is “possessive”.

Top-right—triangle: This modification denotes the addition of Notes in the META data.

Bottom—plus bar (“←”): This modification denotes that this character is an “adverb”.

Bottom—left arrow (“←”): This modification denotes that this character is a “past tense verb”.

Bottom—middle-bar. This modification denotes that this character is a “present tense verb”.

Bottom—right-arrow (“→”): This modification denotes that this character is a “future tense verb”.

Bottom—right-plus (“+”): This modification denotes that this character is an “adjective”.

7. These character modifications are stored in the server-side database and permanently associated with this particular message such that all future references to this communication will find the full set of modifications.

Using the controls found at the top and bottom of the screen, the User has options for navigation to additional functionality of the application:

Using the “Cancel” control located in the upper-left corner, the User may to terminate the particular screen.

Using the “Search” control located in the upper-right corner, the User may initiate a search of the application for a particular language word-character. Once discovered and selected, that action will have initiated the creation of a new conversation to the selected User [FN.sub.—2 LN.sub.—2].

By selecting the “+” control to the right of the “To:” text entry field just below the Cancel control, the User invokes a dialog box that allows selection of a Friend to which the next message will be sent.

The blue space below the To: field and above the Keyboard is used to display both the generated (sent) and received messages to and from one or more Friends. As a limited number of messages may be viewed, the complete history of these is available from the Friends list.

The message client includes a native language search function that enables the User to use his or her own native language as a tool for locating characters. The tool enables the rapid discovery of characters and a means by which a User may learn of other characters of which he or she was nor previously aware.

The Native Language Character Search is conducted as follows:

1. From the keyboard, User selects control ‘Search’ that is identified as a magnifying glass icon.

2. A native language keyboard is invoked.

3. The User enters the first letter of the word associated with the character desired according to how the word is spelled in User's native language.

4. The application responds with a list of all characters whose definition in the User's native language includes the letter entered.

5. The User enters the second letter of the word, as spelled in the User's native language.

6. The application responds with a list of all the characters whose definition in the User's native language includes both the first and second letter entered, immediately juxtaposed to one another in that order.

7. The list of available characters whose definition has both the first and second letter juxtaposed, in the definition of the word in the User's native language is a shorter list than that which was first presented with just one letter.

8. The User continues to add letters to search entry field until the character that best represents the desired word is presented, or until the full word is spelled.

9. If the full word is spelled and the character is presented, the User may select this character that is then immediately, automatically inserted into the message on the previous screen.

10. If the full word is spelled and the character is not presented, the User may review the spelling to make certain it is correct, or delete this word and search for another as it is made obvious that the desired word is not available in the current, local vocabulary.

11. The “Cancel” control returns control to the previous screen and does not modify the selected character.

Character Modification—Location

Any character may be modified to include the location of the User at the time of message creation. This feature is valuable when the User desires to send his or her immediately location to a Friend in order that they may meet at this Location, or to direct attention to the Location for another purpose.

The User adds Location data to any character as follows:

1. From the New screen, message composition window, the User selects any character already displayed in the message composition window.

2. This action invokes the Modification screen.

3. In the upper-left corner of this screen, the definition of the selected character is presented in the User's native language.

4. In the upper-right corner of this screen, the character selected is displayed.

5. Just below “Location” is an orange control with the image of a compass superimposed. Selection of this control conducts an automated location look-up using the built-in GPS coordinate assessment of the PDA or in the case of the web app, a less specific location assumption is made by way of an on-line (open source) IP table look-up function.

6. The result of the Location function, if available, is automatically placed into the text box to the right of the orange compass control and below “Location”.

1. The data is now associated with the given character for this particular message as sent by the given User and upon receipt by the intended recipient Friend.

7. When complete, the User selects “Done” at the bottom-center of the screen.

Character Modification—Notes

Any character may be modified to include Notes that the User desires to append as META data. This feature is valuable when the User desires to include a specific date, time, or proper noun for which there is no character equivalent.

The User adds Notes data to any character as follows:

2. From the New screen, the User selects any character already displayed in the message composition window.

3. This action invokes the Modification screen.

4. Below “Location” and the associated orange compass control and text entry window is “Notes” and its associated data entry window.

5. Selection of the Notes data entry window invokes a keyboard that allows for entry of words in the language native to the User.

6. The result of the Notes entry is contained within the text box immediately below “Notes”. If the amount of data entered is greater than the number of characters allowed by the given text entry window, the application automatically expands the capacity of the entry window with a vertical slider, enabling additional rows of text to be entered and then accessed using the vertical scroll control.

7. The data is now associated with the given character for this particular message as sent by the given User and upon receipt by the intended recipient Friend.

8. When complete, the User selects “Done” at the bottom-center of the screen.

Character Word Type

By default, all characters are assumed to be a noun and without any additional META data. It is only through the modification of any given character that it may gain the communicated value of a verb, adjective, adverb, or additional META data such as Location or Notes.

The User may modify any character to become a verb, adjective, or adverb as follows:

1. From the New screen, the User selects any character already displayed in the message composition window.

2. This action invokes the Modification screen.

3. Below “Location” and “Notes” and their associated on-screen tools, is a series of radio style controls.

4. Selection of the “verb” control invokes a check, signifying the selection as complete.

5. Without any further modification, the verb is assumed to be present tense and will be displayed as such in the prior message composition window of the New screen and upon receipt by the recipient Friend.

6. The User may further modify the designated “verb” character with “past” or “future” tenses and will be displayed as such in the prior message composition window of the New screen.

7. The User may modify the character to become an “adverb” or “adjective” by selection of either control of the same label. Selection of “adverb” attribute will disable “adjective” and vice versa.

8. The User may modify the character to become “possessive”, meaning that the character owns something in the given message, as with the example, “The man's dog ran fast,” the word “man” owns the dog. In this example, the character for “man” would be modified to be possessive.

The System Disclosed Herein is Open:

The system disclosed herein is community developed, much like the open source operating system Linux. Open source is an approach to design, development, and distribution offering practical accessibility to a product's source. Applied to the system disclosed herein, Open Source means the vocabulary is defined and grown by the very users of the system disclosed herein itself. Anyone may download the parameters and tools which guide the creation of a new character for the system disclosed herein. And if accepted by the system disclosed herein language community, that character may be used by anyone in the world, with its META data providing due credit to the author by name, a short story about how the character was created, three unique musical note values which differentiate that character from over 100,000 others, and a means of contacting the author to provide feedback.

The system disclosed herein is also the world's first “open” language, with its vocabulary intended to be built by the very people who use it. Following the model of open-source software development, the framework that governs characters of the system disclosed herein is made available to everyone for free.

Anyone with access to a vector-based painting or design program may create new characters to be added to the global vocabulary. All authors include a story for how they arrived at the design, which makes the system disclosed herein the world's largest, ongoing art and storytelling project in the history of our species.

The artist using the system disclosed herein benefits from the unique interconnections that only a digital language can employ:

Assign a date/time stamp (“birth date”) for each character created by each artist.

Association of the artist's personal story about the creation of each character.

Track the use of the artist's character(s) world-wide.

Any character author may monitor the use of their character(s) as it spreads from a close circle of friends to state, national, and global use.

Users may search for the concurrent or historical use of particular characters and character phrases. When coupled with geo-information and mapping tools, the wave-like propagation of the human experience coupled with current trends in geo-political events becomes an invaluable tool for tracking ideas.

Social scientists may subscribe to sophisticated trends analysis and prediction engines in order to analyze the association of otherwise disparate data sets against the most basic human expression of “I am . . . ”

Monetization of the System Disclosed Herein:

1) Example corporate funding of key icons:

Coke.™ creates a unique icon.

Coke pays OTS each time that icon is transmitted.

Coke gains access to real-time use statistics.

2) Product promotions:

Coke may use real-time stats to locate weak regions in their market regions.

Coke may direct usage traffic to weak regions using PUSH notification.

Users may gain discounts or free product upon arrival.

Vendors receive promotion and sales kickbacks from Coke.

3) 2nd, 3rd language education; on-line tutorials:

Partner with an on-line education company to build ESL

Partner with Rosetta to provide a character for each word.

4) Data mining at various levels:

There exists a unique opportunity for the monetization of the system disclosed herein through paid access to the user statistics. Beyond the real-time monitoring of a single character, the system disclosed herein offers a unique insight into how individuals communicate with each other, how social trends evolve, are adopted, and grow. University and private research programs will benefit from varying degrees of analysis of the system disclosed herein social network statistics over time, as follows:

Usage statistics within a particular time or geographic region.

Restricted to a set of variables (1, 2, or 3 words only).

Restricted to a number of results.

Reduced restrictions.

Unlimited access to all data.

So, Coke can not only create a character which is used in a sentence by tens of thousands of people every day (to replace the more generic “soft drink”) but also conduct real-time demographic monitoring of who is drinking Coke anywhere in the world. That has very real value.

As another example, consider Qdoba.™. and Chipotle.™. restaurants. Either or both can introduce their own character for “burrito” but with their own corporate identity. When User A sends an message to User B, asking to meet for lunch, instead of using a generic character for ‘burrito’, she can use the specific character for “Chipotle” and then include the address and link to an online map (through associated META data) to the exact restaurant. And Chipotle would pay each time this character is used in the system disclosed herein.

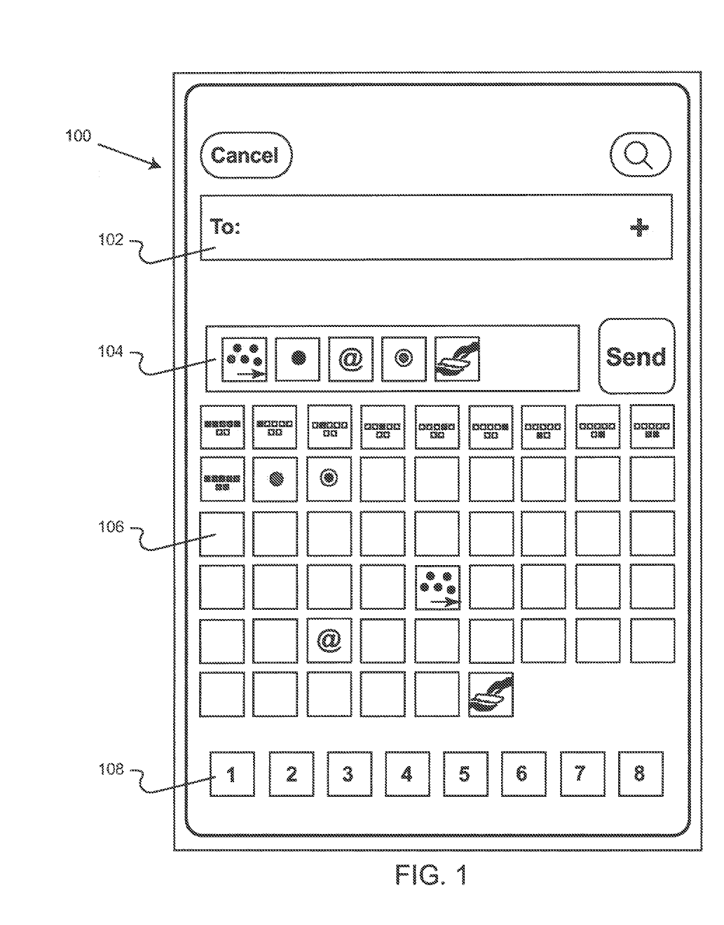

FIG. 1 illustrates an example interface to a new language and communication system. A “To:” field 102 is positioned near the top of the screen. A user can input an identifier of the recipient into the field 102. A sentence field 104 is positioned below the “To:” field 102. Sentence components can be selected from a keyboard region 106, which presents vocabulary components, and input into the sentence field 104 when the user constructs a message. A keyboard category region 108 is positioned below the keyboard region 106 on the screen and can be used to select among different types of keyboards.

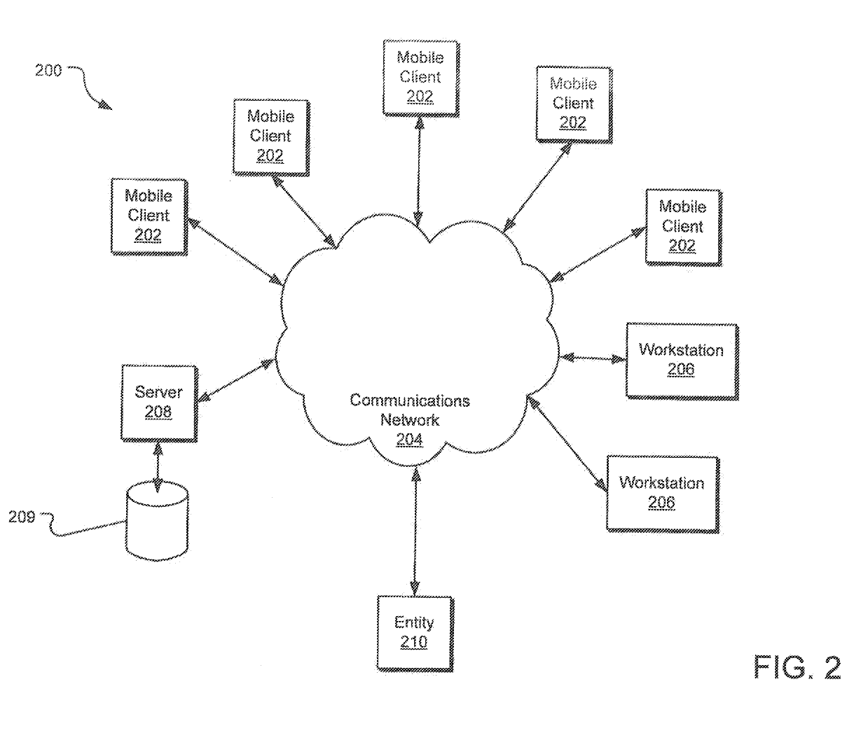

FIG. 2 illustrates an example network connecting various devices in a new language and communication system 200. Individual mobile client devices 202 and workstations 206 are communicatively connected via a network 204. Each mobile client device and workstation (client computer) 206 include a symbol vocabulary database (not show), a messaging module that is capable of capturing a message for transmission, and an interface to send and receive messages via a server 208 (or via a peer-to-pear connection with other mobile client devices and workstations).

The server 208 includes a vocabulary database 209, as well as administrative database (such as a database storing data relating to users of the language and communication system 200, security configuration parameters, etc.

In one implementation, the messages are exchanged between the clients and the server, which forwards the messages on to the appropriate destination clients. Further, the server 208 maintains a database of symbol usage statistics, user locations, etc. to provide commercial data mining opportunities.

It should also be pointed out that, in one implementation, the keyboard system of the language and communications system includes an on-screen interface that, unlike standard keyboard in which the keys themselves are arranged in a fixed order, allows for dynamic reorganization by the user to his or her preferred, most efficient function. For example, a user may organize a set of most frequently used icon keys on a first screen or in a particular location in the dynamic keyboard to facilitate rapid communications.

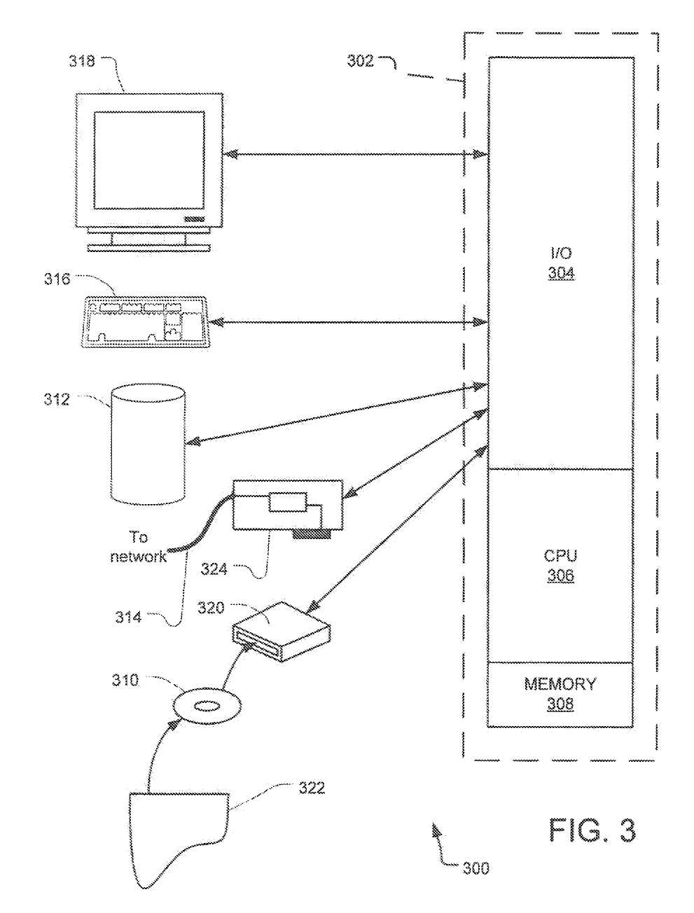

FIG. 3 illustrates an example computing system that can be used to implement the described technology. A general purpose computer system 300 is capable of executing a computer program product to execute a computer process. Data and program files may be input to the computer system 300, which reads the files and executes the programs therein. Some of the elements of a general purpose computer system 300 are shown in FIG. 3 wherein a processor 302 is shown having an input/output (I/O) section 304, a Central Processing Unit (CPU) 306, and a memory section 308. There may be one or more processors 302, such that the processor 302 of the computer system 300 comprises a single central-processing unit 306, or a plurality of processing units, commonly referred to as a parallel processing environment. The computer system 300 may be a conventional computer, a distributed computer, or any other type of computer. The described technology is optionally implemented in software devices loaded in memory 308, stored on a configured DVD/CD-ROM 310 or storage unit 312, and/or communicated via a wired or wireless network link 314 on a carrier signal, thereby transforming the computer system 300 in FIG. 3 to a special purpose machine for implementing the described operations.

The I/O section 304 is connected to one or more user-interface devices (e.g., a keyboard 316 and a display unit 318), a disk storage unit 312, and a disk drive unit 320. Generally, in contemporary systems, the disk drive unit 320 is a DVD/CD-ROM drive unit capable of reading the DVD/CD-ROM medium 310, which typically contains programs and data 322. Computer program products containing mechanisms to effectuate the systems and methods in accordance with the described technology may reside in the memory section 304, on a disk storage unit 312, or on the DVD/CD-ROM medium 310 of such a system 300. Alternatively, a disk drive unit 320 may be replaced or supplemented by a floppy drive unit, a tape drive unit, or other storage medium drive unit. The network adapter 324 is capable of connecting the computer system to a network via the network link 314, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, gaming consoles, set top boxes, etc.

When used in a LAN-networking environment, the computer system 300 is connected (by wired connection or wirelessly) to a local network through the network interface or adapter 324, which is one type of communications device. When used in a WAN-networking environment, the computer system 300 typically includes a modem, a network adapter, or any other type of communications device for establishing communications over the wide area network. In a networked environment, program modules depicted relative to the computer system 300 or portions thereof, may be stored in a remote memory storage device. It is appreciated that the network connections shown are exemplary and other means of and communications devices for establishing a communications link between the computers may be used.

In an example implementation, language system logic and communication system logic may be incorporated in as part of the operating system, application programs, or other program modules. A vocabulary database and various messaging databases may be stored as program data in memory 308 or other storage systems, such as disk storage unit 312 or DVD/CD-ROM medium 310.

It should be understand that circuitry and/or program instructions in one or more switches, one or more administrative workstations, various combinations of one or more switches and one or more workstations, and other computing system implementations may represent example embodiments of the technology described herein.

Characters as Words, Phrases, and Sentences

The described system of communication is comprised of pictographs, graphical characters whose depictions present meaning inherent to the immediate visual elements of the art in addition to a more precise, formal, natural language definition coupled to the art by a computer software database or similar system.

In this described system, each character may through its visual elements and the associated natural language definition convey the meaning of a single word, a group of words, a partial or complete phrase.

An example of three different means of conveying the same concept are as follow (each word in a [bracket] represents a character):

1. [bar] [?]

2. [bar] [10] [clock] [?]

3. [meet] [me] [at] [the] [bar] [at] [10] [clock] [?]

The first example (above) tells the recipient that the message transmitter is asking if the recipient would like to meet at the bar, given the context of an assumed relationship between the two system Users. The second example conveys more detail with the use of additional characters. The third example, while requiring more time to construct, does convey a very precise communication with limited room for misunderstanding by the intended recipient.

As such, individual characters may be transmitted from one User of the described system to another, as a means by which a concept or call to action is conveyed quickly, with limited effort. Multiple characters may be transmitted from one User to another as a more structured communication, in the same way that natural language is sometimes transmitted via text messaging in a short, truncated format or as a full, proper sentence.

The User of the described system is free to use the characters in any given order, either following the structure of his or her native language, or that of his or her choosing, perhaps to present the communication in a format which is more easily understood by the intended recipient, or to express a level of creativity in the conveyed message.

An example of the same meaning conveyed through two different word orders, as follows:

1. [the] [red] [shirt]

2. [the] [shirt] [red]

In both examples (1) and (2) above, the meaning is clear despite the order of the transmitted characters.

An Open Vocabulary

In the described system for communication, the sum of all the characters may be described as a vocabulary for communication. In one method, this vocabulary may be developed and managed entirely by a single artist or a single company.

In another method, this vocabulary may be developed by a community while managed by an individual or company. In another method, this vocabulary may be developed be both developed and maintained by a community, much in the way that the definitions of Wikipedia.org are maintained by a community of authors and editors.

In the methods in which a community develops the characters, the authors may be anyone in the world who creates a unique character to convey an alternative character for an existing definition or to introduce a new, character whose artwork and meaning were previous not present in the described system vocabulary.

In this community developed vocabulary method, the review and acceptance of the new artwork is dictated by one or more individuals who compare the quality of the art itself, as contained with the parameters of the character, to that of the defined standard. In the same respect, the definition is reviewed for its adherence to the defined standards.

In one method, these processes of character art and definition review are conducted via a public facing web interface. In another method, these processes of character art and definition review are conducted by an assigned committee, without public input.

Once any given new character is reviewed and accepted, it may be introduced to the existing vocabulary, thereby expanding the capacity of the described system for use by the whole of the existing and future User base.

Character Author Data

In the described system the author of any given character is enabled to associate information about him or herself such that this information will remain associated with the character in the system vocabulary. This system of author identification and association helps to build a foundation of community support and proliferation where individuals are encouraged to contribute to the growing vocabulary for the reward of being recognized as active, engaged contributors.

In one method, the author is enabled to submit his or her name, origin or current residence, native language, and a short story about how he or she was inspired to develop that given character. Anyone using this system, upon selecting the character in any number of web or application interfaces, may review the information about the author and if invoked, provide feedback to the author about his or her character.

Character Presentation Formats

The characters are, in one method, unconstrained in electronic dimensions as scalable vector art, allowing them to be deployed in a variety of electronic media or reproduced as printed media.

In another method, the characters are constrained to a particular pixel width and height, giving means by which they may be used in a defined communications system, similar to the individual letter characters of a written language displayed on the screen of a computer word processor.

In any method, the density and quality of the images may vary without affecting the intended or conveyed meaning. In one method, the characters are conveyed electronically as 72 DPI (dots per inch) images for display on a traditional electronic viewing medium such as an LCD screen or computer monitor. In another method, the characters are conveyed electronically as 96, 120, or 144 DPI images to maximize quality when viewed on a higher resolution computer or personal, digital device screen such as that incorporated in to the Apple iPad.™. or other such personal, portable tablets.

In another method, the images are printed to a non-electronic medium such as loose paper, bound books, bill boards or other such public signs, shirts, hats, and school bags using a much higher resolution such as 300 or 600 DPI in order to maximize the quality of the image for the reader.

Character Meaning Modification

Unique among modern, digital communication systems, the characters of this described system may be modified by a User of said system to invoke an altered meaning.

This altered meaning may be invoked through the use of a computer software interface such that the applied modification is associated with that particular User's use of the character, in context with the immediate, contextual use. This User invoked, altered meaning does not, in this example, make a permanent change to the foundation character, rather, only to the use of the character by that particular User and by the recipient of that User's message.

In one method, a character whose artwork and definition are presented, by default, as a noun, may be modified to carry the value of a verb which is the action form of the root noun definition. For example, the character for the noun “run”, as used in “I went for a run,” would be modified to transmit instead the verb form of the noun, “to run”, as in “I want to run.”

To function as a replacement of or enhancement to a written language, the character may be modified to carry meaning any number of elemental word types, as with nouns, verbs, adverbs, adjectives, or possessives; and in the case of a verb, also conveying various past, present, or future tenses.

In this one method, the modification of the character to depict this change in definition is a visual element applied to a space reserved in the constrained character boundaries such that the introduction of a new visual element invokes the intended meaning.

For example, a plus sign applied to the bottom right corner of any given character image may transform this character to convey that it should be received as an adjective. In another example, a left facing arrow across the bottom of the character transforms this character convey that is should be received as a verb.

Other examples are given throughout the specification.

Character Meaning Translations

In the described system, the character definitions are translated into multiple languages for the purpose of enabling cross-cultural, cross-language communication without translation by the User who sends the message or the recipient.

In one method, each character is associated with a single definition whose meaning is translated into multiple languages, the resulting, native meaning for each language is stored in a server-side database such that when any given User invokes the display of the meaning, he or she receives it in his or her own, native language, either displayed on-screen as visual text, narrated by a voice synthesis software system, or a combination of both.

In this described method, the original character author may be a native speaker of the English language, and therefore the author's artwork is delivered with the intended, associated meaning in English. A manual, automated, or hybrid method for translation, such as that provided by an electronic dictionary or translation system, is invoked to then provide the same meaning in other languages such as Chinese, German, and Esperanto.

New Language Vocabulary Tool

In another method, the described system for translation may be invoked as a means of assisting with the learning of a new language. In this method, each character may be made available to a User as an integral part of a vocabulary lesson wherein the definition of each character may be presented through a computer software interface in one or more, non-native to the User, languages, each chosen by the User.

In this system for learning a second language, the server-side database structure which houses the multiple language translations is called upon to present the requested language definition.

Character Meaning Search

In the described system for communication using pictographs to convey the meaning of a single word or phrase, there is an implicit need for a means by which any given character may be isolated from the sum of the total vocabulary which may amount to thousands, even tens of thousands of characters.

As such, there are a few methods by which any individual character may be isolated and invoked for use in communication.

In one method, the User enters the first one, two, or three letters of the desired word where the letters entered are, in real-time compared to the definition in the same language of that in use by the User's query, such that a list of all the characters and their associated definitions which contain the same letters as entered by the User are presented. This method requires a relatively fast connection to the server in order that the list is presented in a manner which is not to slow the User in his or her query. The benefit to this method is that the visual feedback grants the User an immediate sense of the characters available, given the letters entered in his or her native language.

In another method, the User enters the entire word prior to submitting the query and the system responds with a list of all characters and their definitions which are equal to or contain the entire word. The benefit to this method is that the User is not inundated with a long list prior to the completion of his or her query, and for slower systems, the query process is not hindered for lack of high speed connection to the server which contains the vocabulary. However, this system presents the potential for greater error for the User will not know, in real-time, without resubmitting a variation on the whole word, whether or not the results of his or her query was in fact accurate given the sum of the words in the total vocabulary.

In another method, the User submits a character itself and the described system responds with confirmation of the character as a member of the vocabulary in addition to the definition in the User's native or selected language.

In another method, the User employs a stylus and electronic tablet, touch screen to a laptop, smart phone, or PDA (personal digital assistant) to draw a rough outline of the character whereby the image is transmitted to the server for analysis and comparison to the sum of all the characters in the total vocabulary. If an image match is made, given the character analysis, the character or characters which are believed to match are presented to the User along with their associated definitions in the User's native or selected language.

In another method, a computer system with camera and software designed for the task is able to translate sign language, that is, a communication system of the torso, arms, hands, fingers, and facial expressions into text which is then compared against the server-side database which contains the sum of the total vocabulary, the resulting characters which match the query presented to the User in the User's native or selected language.

In another method, the User speaks the definition, in his or her native language, into the microphone of a laptop or smart phone or PDA and a server-side voice recognition program translates the spoken words into text which is then compared against the server-side database which contains the sum of the total vocabulary, the resulting characters which match the query presented to the User in the User's native or selected language.

User Applied Metadata

In this described system, the User can add metadata, which is defined by Wikipedia as “data about data”, to any given character prior to its transmission such that the character acts as a carrier of information which is beyond the intrinsic meaning of the art or the definition associated with this character, independent of the language in which it is conveyed.

Were this concept applied to a traditional, written language, it would appear as User A sending the word “egg” to User B but adding to the meaning of the word “egg” the additional meta data for “small, brown” such that when User B receives the word egg in whatever medium he or she is engaged, such as a text messaging application or email client, he or she also receives the words “small, brown” such that is it clear that User A intends to convey the total concept of “small, brown egg.”

In one method, the User is presented with a computer software interface which enables him or her to first select a character to be used in a communication to another User, and then select the character again as one which will be tagged with metadata. In this method, the interface enables the User to enter metadata using his or her native written language such that the pictographic character is delivered to the intended recipient with the meaning intrinsic to its art, the definition associated with the character by the server-side database, and the metadata associated by this one-time invocation by the User, granting a multi-dimensional value to the character.

In this respect, the metadata offers a layer of creativity for the Users in which the characters may be given additional, complementary meaning, or data which has little or nothing to do with the artistic or written definition.

In another method, the metadata is issued by the User through the spoken word, a computer software voice recognition system which translates the spoken words to text which is then associated with the character prior to its transmission.

In another method, the metadata is issued by the User through a digital audio recording, where the digital recording of the User's voice or other sounds is associated with the character prior to transmission such that the recipient receives not a voice-to-text translation of the metadata, but as an audio recording which gives him or her additional meaning when associated with the character.

For example, the character for “dog” could be transmitted with the digital audio recording of a large dog, its voice (bark) clearly not that of a small dog. As such, the recipient would form an image in his or her mind given the association of the image with the audio recording.

In another method, the metadata is issued by the User as digital image where the User has associated a digital image, created by camera or by hand, with the character prior to transmission such that the recipient receives metadata in the form of a digital image.

In another method, the metadata is issued by the User as an audio-video segment, where the digital recording of the User's movements, facial expressions and voice are associated with the character prior to transmission such that the recipient receives the metadata as an audio-video segment.

In all methods, the character itself may be modified to alert the recipient to the inclusion of metadata such that the recipient looks for and activates the metadata transmission if it is not automatically invoked.

(see “Character Meaning Modification”)

Electronic Commerce

In the described system, the vocabulary of characters which are used to convey words, phrases, sentences, and concepts can be comprised of nouns, verbs, adjectives, adverbs, and other elements of both spoken and written language.

In addition to these recognized, standard categories of words, the described system may also differentiate those words which are part of a common, free vocabulary of words used in daily conversation, in any language, and those words which describe proprietary, commercial, and/or copy right protected words such that the owners of these words may benefit from various levels of data about how their characters, which describe their, logos, products, or company, are used in daily communication.

In one method a corporation creates a new character, in a similar fashion to that employed by a community artist (see “An Open Vocabulary”), such that the character art contains a logo, product identity, or art which represents something the corporation desires to promote. The definition of this character is also associated with the logo, product, or promotion such that the natural language words applied to the definition may be searched and used in communication by any given User of the described system.

In one method, the corporation pays for inclusion of one or more characters in the system vocabulary such that the company is enabled to track the use of its characters where such data can include, for example: geographic location of transmission and receipt, quantity of times the character is used in any given geographic region or the total system, world-wide, the context in which the character is used, and the time of day in which the character was transmitted and received.

Server-Side Communications System

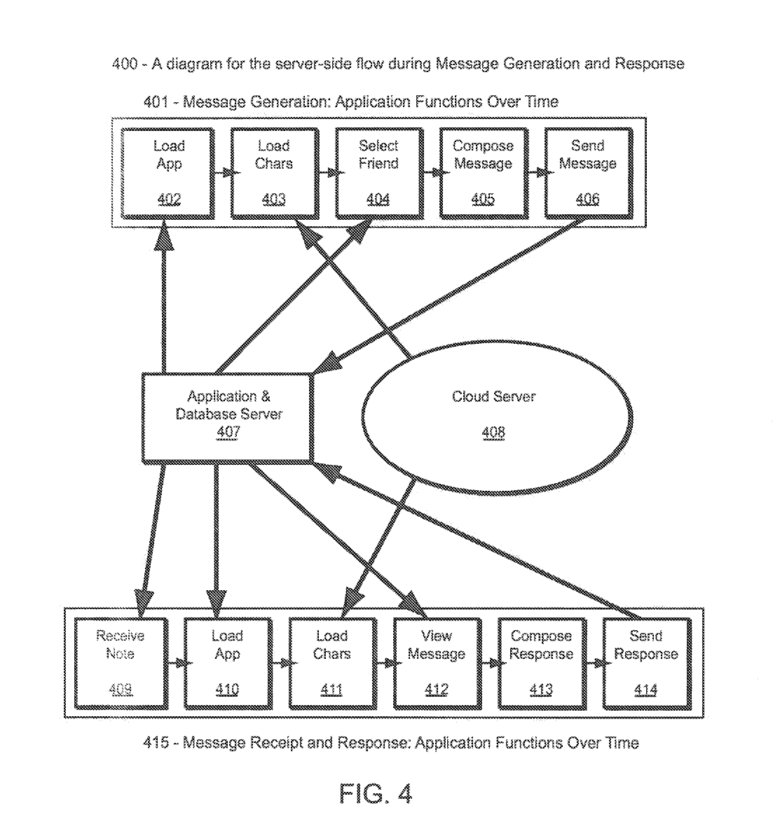

In the described system for communication, the application is served from a centralized server to a web browser and then engaged by the as a web application. In FIG. 4, field 402 represents User 1 application in a web interface, which is upon launched, served to User 1's web browser from the field 407 Application & Database Server.

Next, the web application loads the field 403 characters from the field 408 Cloud Server, which houses the characters for the purpose of distributing the characters to User 1 no matter his or her location, with the least delay and highest quality of service.

In one method, the full character vocabulary is loaded into the web browser application each time User 1 launches the application. In another method, the character vocabulary is stored locally, within the cache or local file store of User 1′s web browser, such that only new or modified characters are loaded from the Cloud Server, reducing the time to load the full, current character vocabulary.

As the characters are being loaded, field 407 Application & Database Server is providing User 1's web application with the definitions of each character in his or her preferred language in order that all search functions (see “Character Meaning Search”) functions are conducted in User 1's native language.

Next, User 1 selects the field 404 intended recipients (Friend) to receive the message which is to be composed in field 405. Composing a message requires no additional communication between the web application and field 407 Application & Database Server or field 408 Cloud Server as all required data and interface controls are at this time available to User 1 via User 1's web interface.

When User 1 in field 406 sends the message to the intended recipient (Friend), this invokes the delivery of the hexadecimal value of each character contained in the message, in the given order (the characters themselves are not sent) coupled with all character modifications made to any of the individual characters and the date, time, location, and User 1 language preference metadata (see “User Applied Metadata” and “Server-Side Character Metadata Management”).

Once the message is received by the field 407 Application & Database Server, the intended recipient is notified via field 409 “push notification” mechanism which results in a text message, email, on-screen or audible prompt on a smart phone or PDA such that the intended recipient is motivated to receive and review the message prepared by User 1.

Now, the intended recipient becomes User 2, wherein he or she launches the field 410 web application in order to receive and review the message sent by User 1. Much in the same fashion as with User 1, User 2's web application in field 411 loads the character vocabulary either in full, or in part in order to update the locally stored cache.

As the characters are being loaded, field 407 Application & Database Server is providing User 2's web application with the definitions of each character in his or her preferred language in order that all search functions (see “Character Meaning Search”) functions are conducted in User 2′s native language.

User 2 now uses field 412 the web application to view the message. If desired, User 2 may now use field 413 to compose a message in response to User 1's received message, sending the hexadecimal values of each character and all associated metadata via field 414, when complete.

As such, User 1 and User 2 do not need to share a common spoken or written language such that the described communications system is providing the definition of each character in any of the supported languages.

Server-Side Character Metadata Management

In the described system, information about the User is tracked with each character or group of character transmissions such that:

Each character is given a unique digital identification such that no two characters share the same alpha-numeric value. To accommodate a vocabulary of more than ten thousand characters, a base-16, hexadecimal (containing the letters A-F and the numbers 0-9) numbering scheme is deployed.

Each character may have one or more forms of metadata associated with it such that the metadata and the character are cross-referenced in the server-side database.

The date, time, location, and contextual association with the full message of each character is stored in the server-side database.

In one method, every character is, at the time of transmission from User to intended recipient, associated with metadata which associates every character with all other characters in the message such that the full message may be reconstructed, all characters reassembled into the format of the original message.

In one method, every character is, at the time of transmission from User to intended recipient, associated with metadata which records every character's User applied modifications (see “Character Meaning Modification”) such that if (for example) a character which by default is a noun is modified to be transmitted as an adjective, it is received in the same way. As such, the unmodified (default) value of that character remains a noun, but when retrieved from the server-side database in the context of that particular message, the character modifiers are also retrieved to invoke the same contextual value in that given message.

In one method, the geographic data is acquired at the point of character transmission using GPS satellite data as provided by the User's laptop, smart phone, or PDA. This geographic position (metadata) of the character at the point of transmission is then stored in the server-side database for future reference, or immediate use by the recipient of the character transmission, if this function is made available in the implementation of the described system.

In one method, the geographic data is acquired at the point of character transmission using TCP-IP triangulation applied to a digital map, such as Google Maps. This geographic position (metadata) of the character at the point of transmission is then stored in the server-side database for future reference, r immediate use by the recipient of the character transmission, if this function is made available in the implementation of the described system.

In one method, a public web interface enables viewing the geographic metadata, for both transmission and receipt, for any character in the active, non-proprietary vocabulary.

]In one method, a private web interface enables viewing the geographic metadata, for both transmission and receipt, for any proprietary character in the active, proprietary vocabulary such that a public interface would not grant access to the same information.

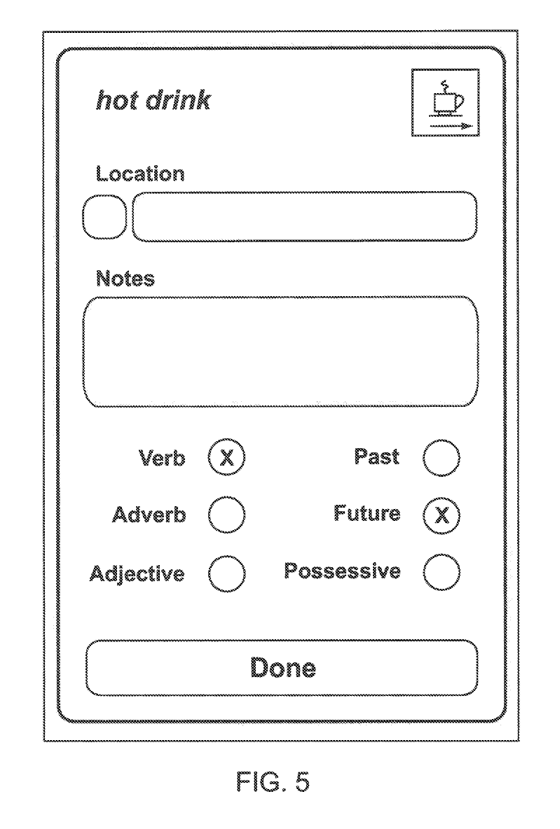

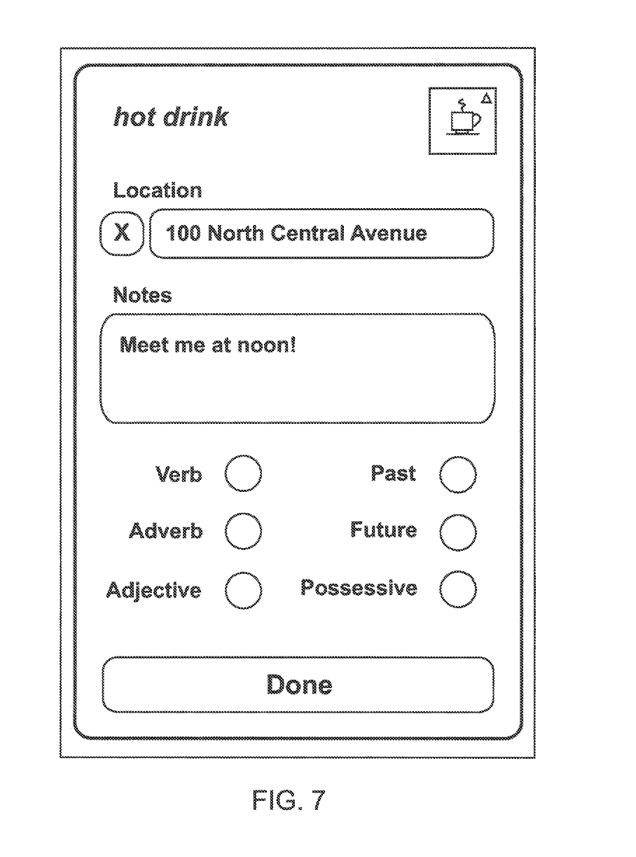

FIG. 5 illustrates an alternative example graphical user interface to that is further described in FIG. 7.

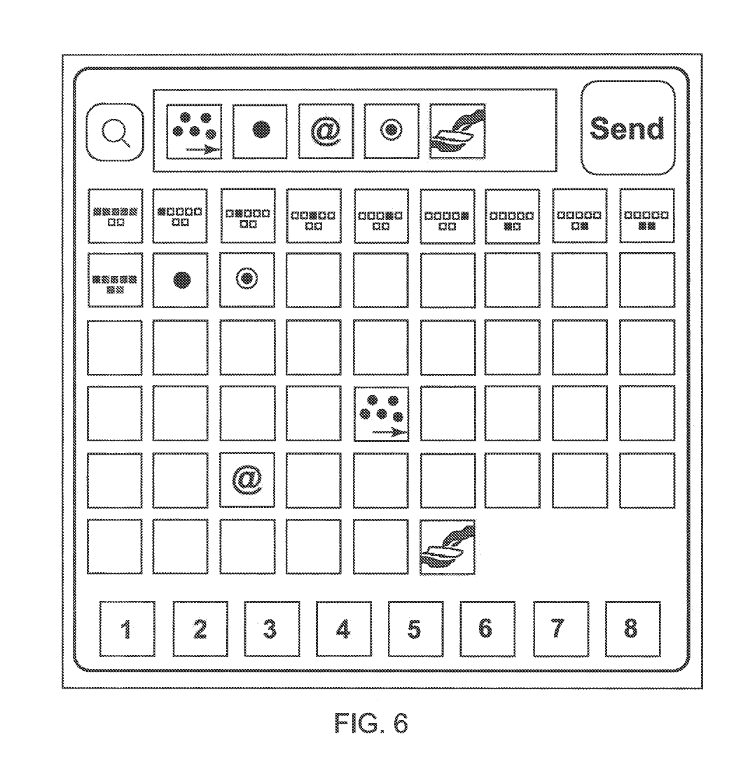

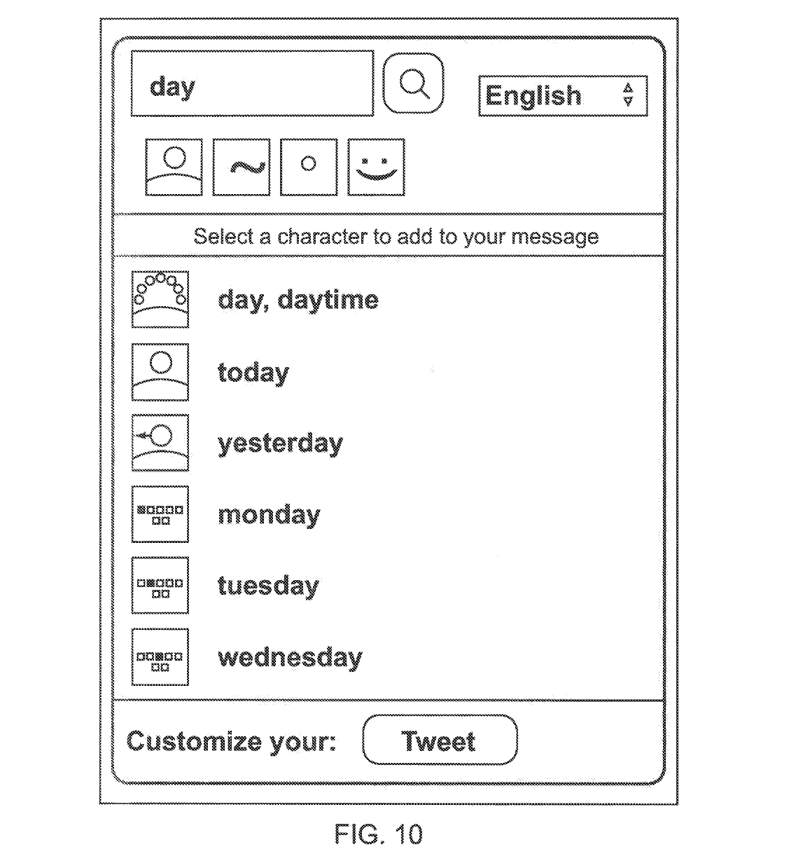

FIG. 6 illustrates an example keyboard layout used by the system disclosed herein. A user can select one of the eight “buckets” where each causes the screen above to refresh with a unique set of characters, in this case, 54 per screen. When any of the characters is selected, a copy is placed in the next adjacent space in the message composition box at the top. The user can also use a natural language key word search function which in real-time presents the user with all characters matching the search, as described in FIG. 10. Characters selected and moved to the message composition box may be reorganized, removed, or modified as described by FIG. 5, above. The user can rearrange the keyboard, moving characters from one “bucket” to the next or within the same “bucket” keyboard in order to create a customized keyboard layout which is more efficient for that particular user. This keyboard configuration is recalled each time the user uses the application, in a web browser or on a portable, personal device such as an Apple iPod.

FIG. 7 illustrates an example graphical user interface that allows a user to modify a noun to be displayed and transmitted as a verb, with past, present, or future tense; as an adverb, adjective, or possessive. The user can add notes written in his or her native language, to send to the intended recipient. In addition, the user can choose to transmit his or her present location to the intended recipient. All of these described functions are described elsewhere in this document.

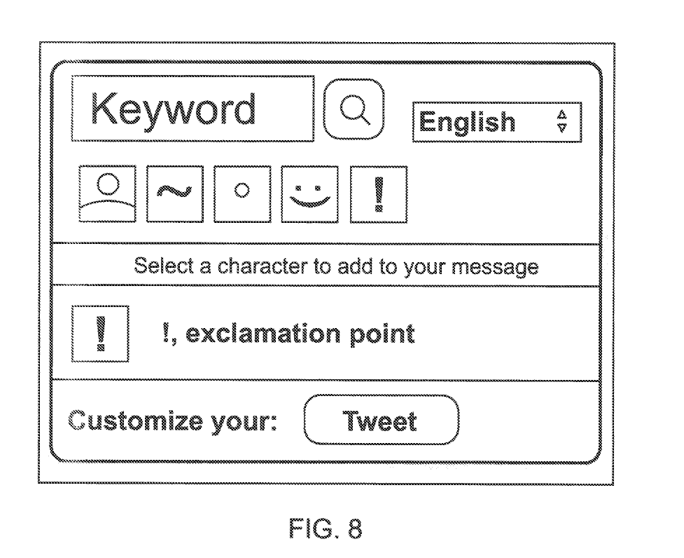

FIG. 8 illustrates an example graphical user interface that allows a user to prepare a message to be transmitted to a Twitter message. This interface is a lite version of the full keyboard interface described in FIG. 6 wherein characters are selected using the real-time natural language, key word search without the special keyboard, as described in FIG. 10.

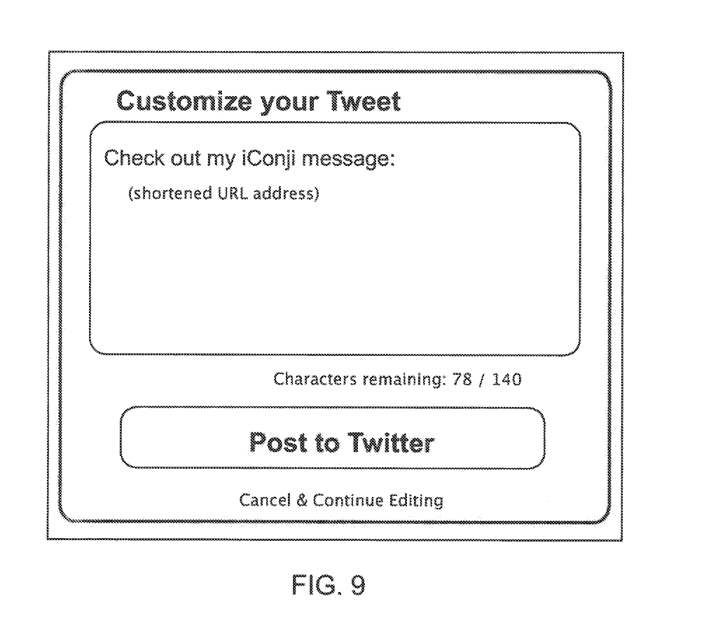

FIG. 9 illustrates an example graphical user interface that follows the interface described in FIG. 8 which allows a user to enhance a Twitter message by adding natural language text to the primary character message. In this respect, the user can either duplicate the meaning in his preferred language, or add text which is not connected to the primary character message.

FIG. 10 illustrates an example graphical user interface that allows a user to conduct a natural language key word search in real-time where all characters in the current vocabulary are presented as options for message composition.

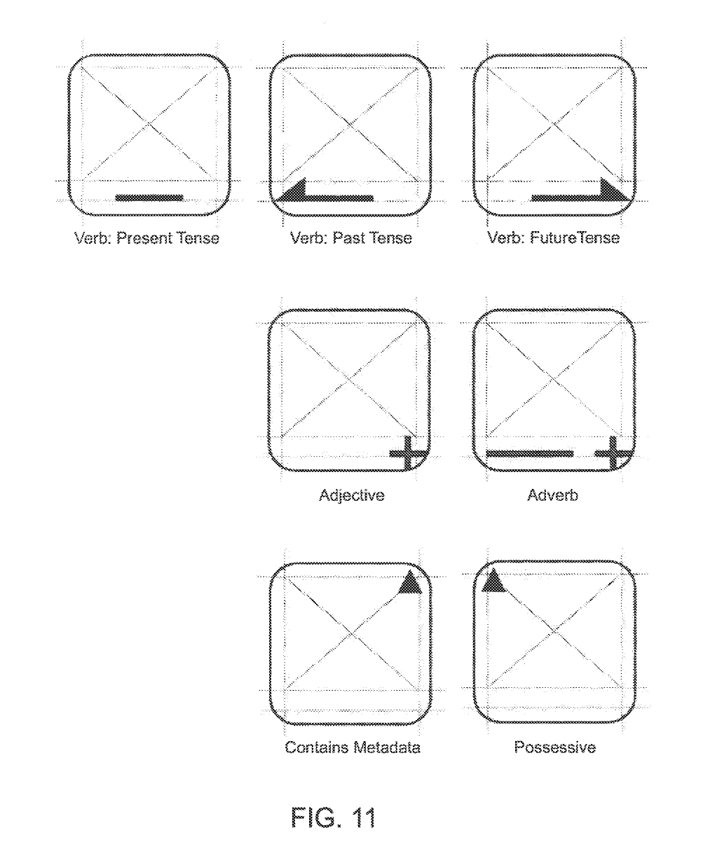

FIG. 11 illustrates example diagrams and descriptions of modifiers. All characters are presumed to be a noun unless otherwise modified and noted. A single bar across the bottom-CENTER of the character bounding box denotes a present tense verb. A single bar across the bottom-CENTER of the character bounding box with an arrow pointing to the RIGHT denotes a future tense verb. A single bar across the bottom-center of the character bounding box with an arrow pointing to the LEFT denotes a past tense verb. A “+” sign on the bottom-RIGHT of the character bounding box (with no other notation) denotes an adjective. A single bar across the bottom-center of the character bounding box followed by a “+” sign on denotes an adverb.

A DIAMOND shape in the upper-LEFT corner of the character bounding box denotes a character which includes META data, additional information attached to the character in the User's native language, such as a street address or a person's name. A modified DIAMOND shape in the upper-RIGHT corner of the character bounding box denotes a noun which POSSESSES ownership of something. For example, “The man's truck” where the character for “man” would include the POSSESSIVE modifier to demonstrate his ownership of the truck. A sample of an unmodified character in its raw (un-published) state with the character bounding box displayed. In this instance, the character meaning is “food”.

The implementations of the presently disclosed technology described herein are implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the presently disclosed technology. Accordingly, the logical operations making up the implementations of the presently disclosed technology described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of example implementations of the presently disclosed technology. Since many implementations of the presently disclosed technology can be made without departing from the spirit and scope of the presently disclosed technology, the presently disclosed technology resides in the claims hereinafter appended. Furthermore, structural features of the different implementations may be combined in yet another implementation without departing from the recited claims.

What is claimed is:

1. A keyboard system comprising:
a touch screen interface;
one or more computer readable storage media configured to store:
a database comprising a plurality of different keyboard configurations, each of the keyboard configurations representing a plurality of keys to be displayed on the touch screen interface; and
one or more computer executable instructions for performing a computer process, the computer process comprising displaying one or more of the plurality of keys on the touch screen interface.

2. The keyboard system of claim 1, wherein the one or more of the plurality of keys represents a word of more than one character.

3. The keyboard system of claim 2, wherein the computer process comprising:
receiving an input from a user to move one of the plurality of keys from a first of the plurality of different keyboard configuration to a second of the plurality of keyboard configuration; and
changing the first and the second keyboard configurations in the database.

4. The keyboard system of claim 2, wherein each of the plurality of keyboard configurations allows the user to use the each of the plurality of keys without requiring any scrolling.

5. The keyboard system of claim 2, wherein the computer process further comprising:
receiving an input indicating selection of a first of the plurality of different keyboard configurations; and
displaying plurality of keys represented by the first keyboard configuration.

6. The keyboard system of claim 5, wherein the computer process further comprising:
receiving an input indicating selection of one of the plurality of keys represented by the first keyboard configuration; and
displaying a first word represented by the one of the plurality of keys of the second configuration in an outgoing message field.

7. The keyboard system of claim 6, wherein the computer process further comprising:
receiving another input indicating selection of a second of the plurality of different keyboard configurations;
displaying plurality of keys represented by the second keyboard configuration;
receiving an input indicating selection of one of the plurality of keys represented by the second keyboard configuration; and
displaying a second word represented by the one of the plurality of keys of the second configuration in the outgoing message field together with the first word.

8. The keyboard system of claim 1, wherein the database comprises eight different keyboard configurations.

9. The keyboard system of claim 1, wherein one or more of the plurality of keys represents a phrase comprising more than one word.

10. The keyboard system of claim 1, wherein the keys represented by the one or more of the plurality of keyboard configurations is categorized in a predetermined manner.

11. The keyboard system of claim 10, wherein a user defines a plurality of categories used to categorize the one or more of the plurality of keyboard configurations.

12. The keyboard system of claim 10, wherein each of the keys represented by one of the plurality of keyboard configurations represents a phrase comprising more than one word.

13. The keyboard system of claim 2, wherein the computer process further comprising:
receiving a search query for a search word; and
in response to the search query, presenting one of the plurality of keyboard including a key representing the search word.

14. A method, comprising:
receiving user input on a touch screen interface; and
presenting one of a plurality of keyboards via the touch screen interface in response to the user input.

15. The method of claim 14, wherein each of the one of more of the plurality of keyboards includes a plurality of keys and each of the plurality of keys represents a word.

16. The method of claim 15, wherein each of the plurality of keys and represents a word of more than one character.

17. The method of claim 15, further comprising:
receiving an input from a user to move one of the plurality of keys from a first of the plurality of different keyboards to a second of the plurality of keyboards; and
changing a first configuration related to the first keyboard and a second keyboard configuration related to the second keyboard in a database comprising a plurality of different keyboard configurations.

18. The method of claim 15, further comprising:
receiving an input indicating selection of one of the plurality of keys represented by the first keyboard configuration; and
displaying a first word represented by the one of the plurality of keys of the second configuration in an outgoing message field.

19. The method of claim 15, further comprising:
receiving a search query for a search word; and
in response to the search query, presenting one of the plurality of keyboard including a key representing the search word.

20. A device comprising:
a touch screen interface configured to display a plurality of different keyboard configurations, each of the keyboard configurations representing a plurality of keys, receive an input from a user to select one of a plurality of keyboard selection inputs, and in response to the selection of the one of a plurality of keyboard selection inputs, displaying a selected keyboard configuration from the plurality of different keyboard configurations, wherein each of the plurality of keys related to the selected keyboard configuration represents a word.
